(19) United States
(12) Patent Application Publication
(10) Pub. No.: US 2024/0390758 A1
(43) Pub. Date: Nov. 28, 2024

(54) INTERFACE APPARATUS AND CLIMBING EXPERIENCE SYSTEM

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 18/665,002

(22) Filed: May 15, 2024

(30) Foreign Application Priority Data
May 26, 2023 (JP) 2023-087223

(51) Int. Cl. A63B 69/00

(52) U.S. Cl. CPC A63B 69/0048; A63B 2220/833; A63B 2220/836; A63B 2225/50

(57) ABSTRACT

An interface apparatus configured to provide a user with a climbing experience in a virtual space includes: a board to which holds are attached; a movement mechanism configured to move positions of the holds on the board; force sensors that each detect a force and a moment which are applied from the user to a corresponding one of the holds or which are applied from each of the holds to the user; and an input and output section that provides a signal indicative of the force and the moment to a simulation apparatus configured to generate the virtual space and that acquires, from the simulation apparatus, a control signal for controlling the movement mechanism so as to move the holds.

This Nonprovisional application claims priority under 35 U.S.C. § 119 on Patent Application No. 2023-087223 filed in Japan on May 26, 2023, the entire contents of which are hereby incorporated by reference.

### TECHNICAL FIELD

The present invention relates to an interface apparatus and a climbing experience system.

### BACKGROUND ART

Conventionally, an apparatus imitating, for example, a simulated rock wall for climbing has been known. Patent Literature 1 discloses a system for combining a climbing wall and a swing mechanism. Patent Literature 2 discloses a constructible stationary artificial wall apparatus for climbing which can be easily assembled, disassembled, moved, and changed in an inclination angle of an artificial wall.

### CITATION LIST

### Patent Literature

[Patent Literature 1]
Published Japanese Translation of PCT International Application Tokuhyo No. 2021-534923
[Patent Literature 2]
Japanese Patent Application Publication Tokukai No. 2003-93569

### SUMMARY OF INVENTION

### Technical Problem

However, such a conventional technology poses a problem that a large-scale apparatus is required for achieving climbing with a distance beyond a certain point.

An aspect of the present invention has been achieved in light of the foregoing problem. It is an object of the aspect of the present invention to enable a relatively small-scale configuration to provide a user with a climbing experience with a distance beyond a certain point.

### Solution to Problem

In order to solve the foregoing problem, an interface apparatus in accordance with an aspect of the present invention is an interface apparatus configured to provide a user with a climbing experience in a virtual space, the interface apparatus including: a board to which holds are attached, the user being to put a hand or a foot of the user at each of the holds; a movement mechanism configured to move positions of the holds on the board; force sensors which are provided to at least one selected from the group consisting of (i) the holds and (ii) gloves and shoes worn by the user and which each detect a force and a moment that are applied from the user to a corresponding one of the holds or that are applied from each of the holds to the user; and an input and output section that provides a signal indicative of the force and the moment to a simulation apparatus configured to generate the virtual space and that acquires, from the simulation apparatus, a control signal for controlling the movement mechanism so as to move the holds.

Further, in order to solve the foregoing problem, a climbing experience system in accordance with an aspect of the present invention includes: the interface apparatus; and the simulation apparatus, the simulation apparatus determining the positions of the holds on the board in view of a position of the user in the virtual space and a posture of the user which posture has been specified by the force and the moment.

### Advantageous Effects of Invention

An aspect of the present invention enables a relatively small-scale configuration to provide a user with a climbing experience with a distance beyond a certain point.

### BRIEF DESCRIPTION OF DRAWINGS

FIG. 1 is a perspective view illustrating an example of a system.

FIG. 2 is an example of a functional block diagram of the system.

FIG. 3 is an example of a view schematically illustrating a board as viewed from a negative X-axis direction.

FIG. 4 is an example of a VR image representing the both hands of a user.

FIG. 5 is an example of a sequence diagram illustrating an operation of the system.

FIG. 6 is a view for explaining an operation example of a movement mechanism.

### DESCRIPTION OF EMBODIMENTS

The following description will discuss an embodiment of the present invention in detail.

### <Configuration Example of Climbing Experience System>

A climbing experience system in accordance with the present embodiment (hereinafter, also referred to as “system S”) provides a user U with a climbing experience in a virtual space. The “climbing” in the present disclosure includes, for example, free climbing, lead climbing, and bouldering. Further, movement of descending a wall surface and lateral movement on a wall surface are also included.

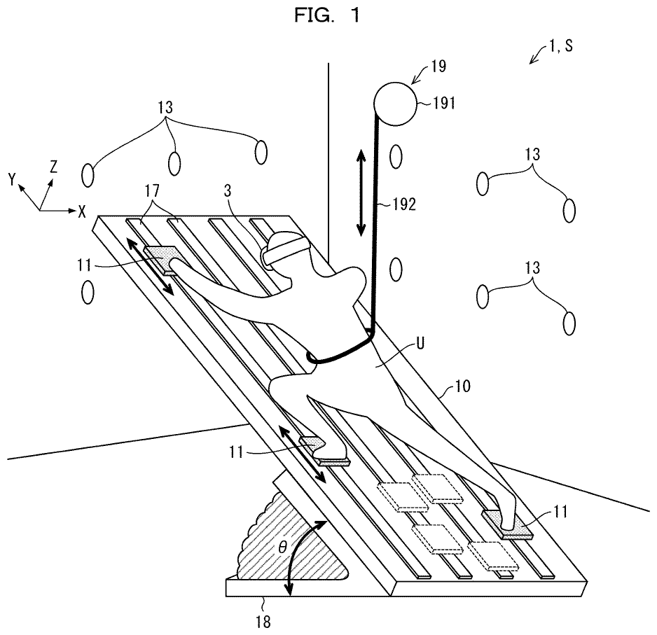

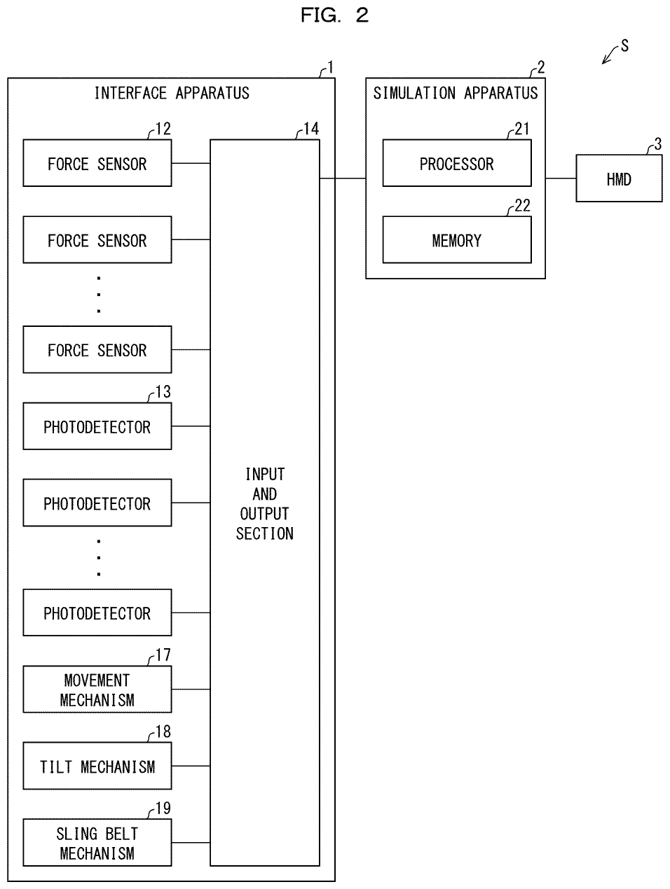

FIG. 1 is a perspective view illustrating an example of the system S. FIG. 2 is a functional block diagram illustrating an example of the system S. As illustrated in FIGS. 1 and 2, the system S includes an interface apparatus 1, a simulation apparatus 2, and a head mounted display 3 (hereinafter, also referred to as “HMD 3”). As illustrated in FIG. 2, the components 1 to 3 are communicably connected with each other in a wired or wireless manner.

### [Interface Apparatus]

The interface apparatus 1 is an apparatus serving as a physical interface for the user U in a climbing experience. As illustrated in FIGS. 1 and 2, the interface apparatus 1 includes a board 10, holds 11, a movement mechanism 17, a tilt mechanism 18, a sling belt mechanism 19, photodetectors 13, and an input and output section 14. Note that in each of FIGS. 1 and 2, some members which are illustrated in the other drawing are omitted. In addition, the holds 11 include force sensors 12, as described later.

### [Board]

The board 10 is a board which the user U is to climb or descend in a climbing experience. The holds 11, the movement mechanism 17, the tilt mechanism 18, and the photodetectors 13 which are described later may be understood to be included in the board 10 or may be understood to be each a separate member to be attached to the board 10. In the drawings subsequent to FIG. 1, coordinate axes along sides of the board 10 are illustrated. Note that a shape of the board 10 is not limited to a cuboid.

### (Hold)

Each of the holds 11 is a member which is attached to the board 10 and at which the user U is to put a hand or a foot of the user U. The movement mechanism 17 causes each of the holds 11 to move in a Y-axis direction and a Z-axis direction. In an example of FIG. 1, the holds 11 are provided in four rows in an X-axis direction of the board 10. The number of rows in which the holds 11 are provided on the board 10 is not limited, but a configuration is desirable in which the holds 11 are provided on the board 10 in at least two rows for both hands and both feet. Further, it is desirable that in each of the rows, at least two holds 11 are provided.

As a movement in the Z-axis direction, at least part of each of the holds 11 is switchable between a state in which the at least part is lifted off from the surface of the board 10 by approximately several millimeters or several centimeters and a state in which the at least part is recessed toward the surface of the board 10. In other words, a position of at least part of each of the holds 11 is switchable, in the Z-axis direction which is perpendicular to the surface of the board 10, between a first position in which the user U can put a hand or a foot of the user U at the at least part and a second position which is closer to the surface of the board 10 than the first position is.

More desirably, a configuration is possible in which the Z-axis-direction position of at least part of each of the holds 11 is switchable among multiple levels. This configuration makes it possible to use the holds 11 to imitate, for example, protrusions with any sizes on a rock wall in a virtual space. Note that the present disclosure also includes a configuration in which the Z-axis-direction position of each of the holds 11 is unswitchable.

### (Force Sensor)

The force sensors 12 are provided to holds 11 and are each configured to detect a force and a moment which are applied from the user U to the corresponding one of the holds 11. Thus, the force sensor 12 can detects, for example, whether or not a hand or a foot of the user U is in contact with the hold 11 and in which direction the hand or the foot of the user U applies a force to the hold 11.

Note that another aspect is possible in which the force sensors 12 are provided to gloves and shoes worn by the user U, and the force sensors 12 detect forces and moments which are applied from the holds 11 to the user U. Further, a configuration is also possible in which the force sensors 12 are provided to both (i) the holds 11 and (ii) the gloves and shoes worn by the user U.

### (Movement Mechanism)

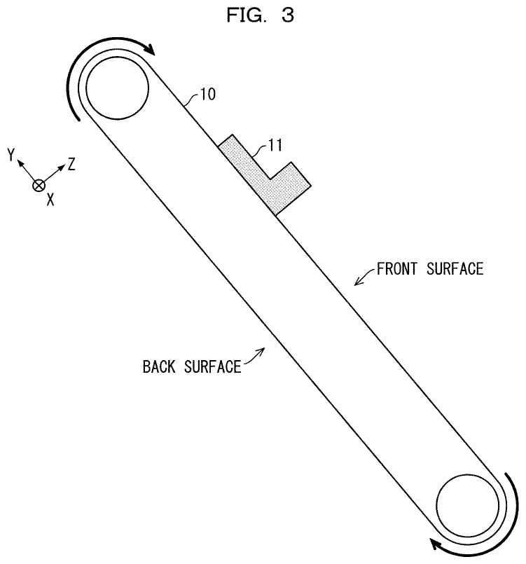

The movement mechanism 17 moves the position of each hold 11 in the Y-axis and Z-axis directions on the board 10 on the basis of a control signal that has been inputted from the simulation apparatus 2. A part of the movement mechanism 17 is achieved with use of, for example, a rail or a belt. FIG. 3 is an example of a view schematically illustrating the board 10 as viewed from a negative X-axis direction. The user U engages in a climbing experience on the front surface of the board 10. In a case where the movement mechanism 17 is achieved with use of a belt, the belt circularly passes the front surface of the board 10 and the back surface or inside of the board 10. Note that, for example, a configuration is also possible in which the holds 11 are flexible or foldable and also circularly pass the front surface of the board 10 and the back surface or inside of the board 10. The process performed by the movement mechanism 17 will be described later in detail.

### (Tilt Mechanism)

The tilt mechanism 18 supports the board 10 such that the board 10 is tiltable in accordance with a control signal which has been inputted from the simulation apparatus 2. The tilt mechanism 18 changes an angle θ between the board 10 and the floor surface, which is illustrated in FIG. 1. The tilt mechanism 18 can be achieved with use of, for example, a servomotor and a gear. A configuration is more desirable in which the tilt mechanism 18 can change the angle θ even while the user U is climbing. Further, the angle θ may be more than 90°.

### [Sling Belt Mechanism]

The sling belt mechanism 19 includes a body 191 provided on or in the vicinity of the ceiling and a belt 192 that can be drawn from the body 191, like a reel tape measure. A tip of the belt 192 is, for example, a loop to be attached to the body of the user U. When a force by which the belt 192 is drawn exceeds a certain point, the sling belt mechanism 19 suppresses the drawing of the belt 192 so as to prevent the user U from falling from the board 10. Further, a configuration is also possible in which information indicative of a speed at which the belt 192 is winded up or a speed at which the belt 192 is drawn is provided to the simulation apparatus 2 via the input and output section 14, as information for calculation of a movement speed at which the user U climbs.

### [Photodetectors]

The photodetectors 13 detect light emitted from the HMD 3. The plurality of photodetectors 13 may be provided on the wall surface so as to surround the board 10, as exemplified in FIG. 1. In addition, the photodetectors 13 may be provided on the front surface of the board 10; or on the ceiling or floor surface of the room. In addition, the photodetectors 13 in accordance with the present embodiment are provided in a matrix at a predetermined interval. Note that, for example, the photodetectors 13 may be provided so as to be obliquely aligned or may be provided randomly.

### [Input and Output Section]

The input and output section 14 provides a detection signal to a simulation apparatus 2. The detection signal indicates a force and a moment which are applied from the user U to each of the holds 11 or which are applied from each of the holds 11 to the user U. Further, the input and output section 14 acquires, from the simulation apparatus 2, a control signal for controlling the movement mechanism 17 so as to move the holds 11 and a control signal for controlling the tilt mechanism 18 so as to tilt the board 10. The input and output section 14 is constituted by a communication module that communicates with the simulation apparatus 2 in a wired or wireless manner or a terminal for wired connection with the simulation apparatus 2.

The input and output section 14 in accordance with the present embodiment provides the simulation apparatus 2 with identification information (for example, ID and attachment position) of the photodetector 13 that has detected the light emitted by the HMD 3. In other words, the information indicative of the photodetector 13 that has detected light is provided to the simulation apparatus 2 via the input and output section 14, as information for specifying an orientation of the HMD 3.

### [Simulation Apparatus]

The simulation apparatus 2 generates a virtual space and outputs a control signal. In a case where the climbing experience provided by the system S is a rock climbing experience, the virtual space is a space including a rock wall. In a case where the climbing experience is a bouldering experience, the virtual space is a space including a wall surface for bouldering. Further, the simulation apparatus 2 may generate a virtual space including, for example, a wall surface of a building or tower in which climbing is typically not performed. As illustrated in FIG. 2, the simulation apparatus 2 includes a processor 21 and a memory 22.

### (Memory)

The memory 22 stores a control program for causing the simulation apparatus 2 to operate. The memory 22 in accordance with the present embodiment also stores image data for generating the virtual space.

### (Processor)

The processor 21 generates, for example, on the basis of graphics data obtained by taking a picture of a place to actually experience climbing experience, a VR (Virtual Reality) image imitating scenery of a virtual space (for example, a rock wall) suited to a climbing experience provided by the system S. Note that this should not be construed as a limitation and the processor 21 may generate a VR image of scenery of a virtual space which does not exist in the real word.

The VR image moves in accordance with a movement of the user U in climbing and the orientation of the HMD 3. In addition, the processor 21 in accordance with the present embodiment specifies an orientation of the face of the user U on the basis of the identification information of the photodetector 13 that has detected the light and causes the virtual space to rotate in accordance with the orientation of the face of the user U.

In terms of another perspective, the processor 21 refers to a detection signal that has been provided from the input and output section 14 and information indicative of the photodetector 13 that has detected light, to generate an image of a scene which the user U in the virtual space would see. The processor 21 then transmits, to the HMD 3, data on the virtual space generated, via a communication module which is not illustrated.

Further, the processor 21 determines an operation of the tilt mechanism 18 and positions of the holds 11 on the board 10, that is, an operation of the movement mechanism 17, on the basis of a position of the user U in the virtual space and a posture of the user U which has been specified by a force and a moment that are applied from the user U to each of the holds 11 or that are applied from each of the holds 11 to the user U.

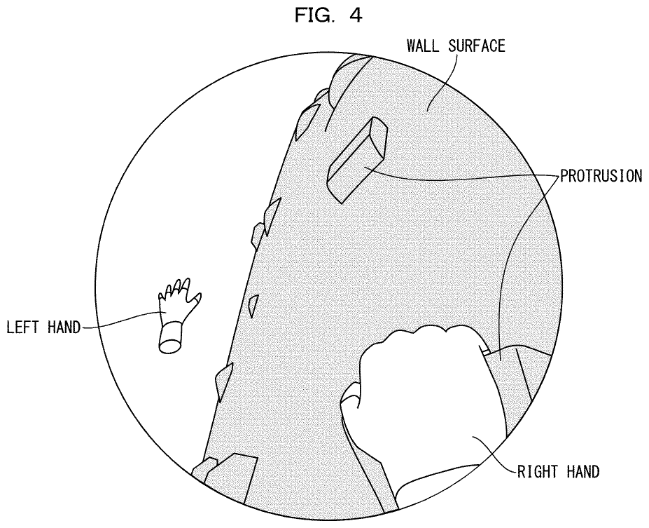

Furthermore, the processor 21 may generate a VR image representing a virtual space including part or whole of the body of the user U in the posture specified and provide the VR image to the HMD 3. FIG. 4 illustrates an example of a VR image representing the both hands of the user U. In FIG. 4, the protrusions at which the user U can put the hand or foot of the user U correspond to the holds 11 each in the first position described above.

In addition, the processor 21 may generate a VR image which represents a virtual space including part or whole of the body of an avatar of, for example, a figure other than the user U or a character. This makes it possible to provide the user U with, for example, a climbing experience together with a professional climber.

In addition, the processor 21 may be configured to generate a sound in the virtual space and transmit the sound to the HMD 3. In a case where the climbing experience provided by the system S is a rock climbing experience, the sound may include, for example, sounds of winds and cries of birds.

### [HMD (Head Mounted Display)]

The HMD 3 displays an image which represents the virtual space and which has been acquired from the simulation apparatus 2. The HMD 3 is worn on the head of the user U when the user U engages in a climbing experience. This makes it possible to provide the user U with realistic feeling as if the user U existed in the virtual space. The simulation apparatus 2 in accordance with the present embodiment generates a VR image and thus enables the user U wearing the HMD 3 to feel as if the user U existed in a more realistic virtual space. In addition, the simulation apparatus 2 in accordance with the present embodiment generates an image that moves in accordance with a movement of the user U in climbing and an orientation of the HMD 3, and thus the user U wearing the HMD 3 can feel as if the user U was climbing or descending a wall surface.

At least while the user U experiences climbing, the HMD 3 in accordance with the present embodiment emits light in a predetermined direction, for example, in a direction in which the user U's face is oriented. The light needs only differ from light in the interior of the room in which the interface apparatus 1 is installed and may be, for example, visible light or infrared light. The light emitted from the HMD 3 is detected by any of the plurality of photodetectors 13 provided around the interface apparatus 1 or on the board 10.

Note that the HMD 3 may contain a speaker. In this case, the HMD 3 may be configured to output a sound in the virtual space which has been acquired from the simulation apparatus 2.

Note that the present disclosure also includes a configuration in which the orientation of the HMD 3 is specified by, for example, a gyrosensor contained in the HMD 3 and a configuration in which the user U engages in a climbing experience without the HMD 3.

### <Operation Example of Climbing Experience System (Interface Apparatus)>

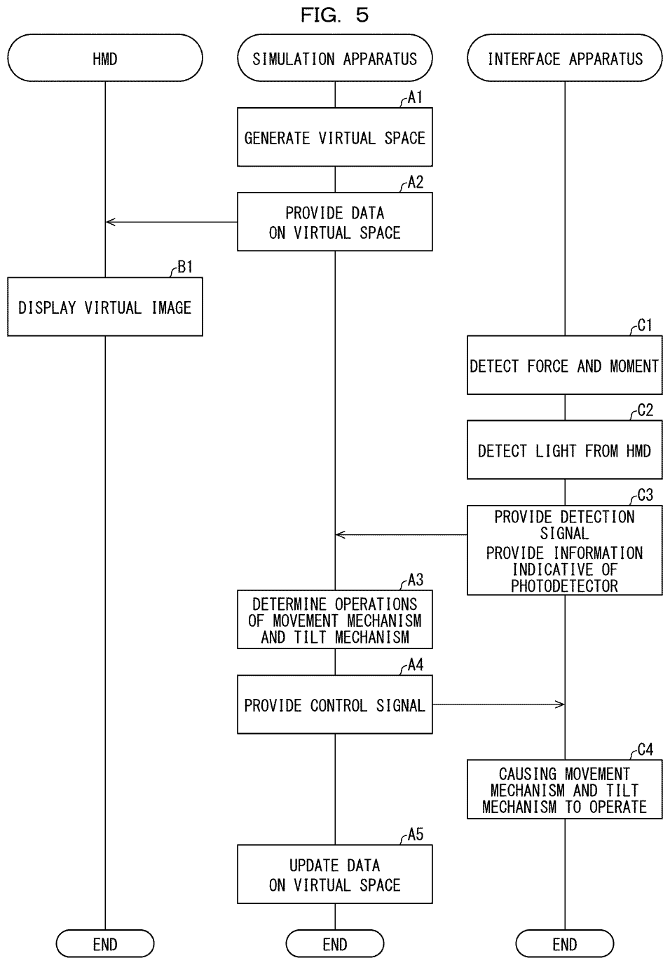

Next, the following description will describe an operation of the system S. FIG. 5 illustrates an example of a sequence diagram illustrating an operation of the system S.

The system S configured as above starts the operation illustrated in FIG. 5 when a predetermined start condition is satisfied. Examples of the start condition include the followings: the system S (interface apparatus 1) is turned on; putting of the hand and the foot of the user U at holds 11 on the board 10 is detected; and the user U performs a predetermined start operation.

When the system S starts its operation, the simulation apparatus 2 first generates a virtual space (step A1) and then provides the data on the virtual space to the HMD 3 worn by the user U (step A2), as illustrated in FIG. 5. The HMD 3 that has received the data on the virtual space displays a VR image of the virtual space on a display contained in the HMD 3 (step B1).

The interface apparatus 1 is configured such that while the HMD 3 displays the virtual space, each force sensor 12 repeatedly detects, at a predetermined cycle, a force and a moment acting thereon (step C1), and each photodetector 13 repeats, at a predetermined cycle, a process of detecting light emitted from the HMD 3 (step C2). Every time the force sensor 12 detects the force and the moment, the input and output section 14 provides the detection signal to the simulation apparatus 2. Further, every time the photodetector 13 detects light from the HMD 3, the input and output section 14 provides the simulation apparatus 2 with information indicative of the photodetector 13 that has detected light (step C3).

Then, the simulation apparatus 2 that has acquired the detection signal determines an operation of the movement mechanism 17 and an operation of the tilt mechanism 18 on the basis of a state of the virtual space generated and the posture of the user U which has been specified by the detection signal (step A3). In addition, when the simulation apparatus 2 determines the operation of the movement mechanism 17 and the operation of the tilt mechanism 18, the simulation apparatus 2 may refer to information which has been provided from the sling belt mechanism 19.

The simulation apparatus 2 then provides the interface apparatus 1 with a control signal indicative of the determined operations of the movement mechanism 17 and the tilt mechanism 18 (step A4). The interface apparatus 1 that has acquired the control signal causes the movement mechanism 17 and the tilt mechanism 18 to operate, in accordance with the control signal provided (step C4). Further, the simulation apparatus 2 updates the data on the virtual space on the basis of the state of the virtual space generated and the posture of the user U which has been specified by the detection signal (step A5). The processes of the step A2 and the steps following the step A2 of FIG. 5 are performed again with use of the upgraded data on the virtual space. Therefore, in the following step B1, an image which moves in accordance with a movement of the user U in climbing and an orientation of the HMD 3 is displayed on the HMD 3.

The process illustrated in FIG. 5 ends in a case where a predetermined end condition is satisfied. Examples of situations that satisfy the end condition include elapsing of a predetermined time period, arrival at a goal in climbing, an end operation performed by the user U, and a determination that the user U has fallen from the wall surface, as described later.

### <Operation Example of Movement Mechanism>

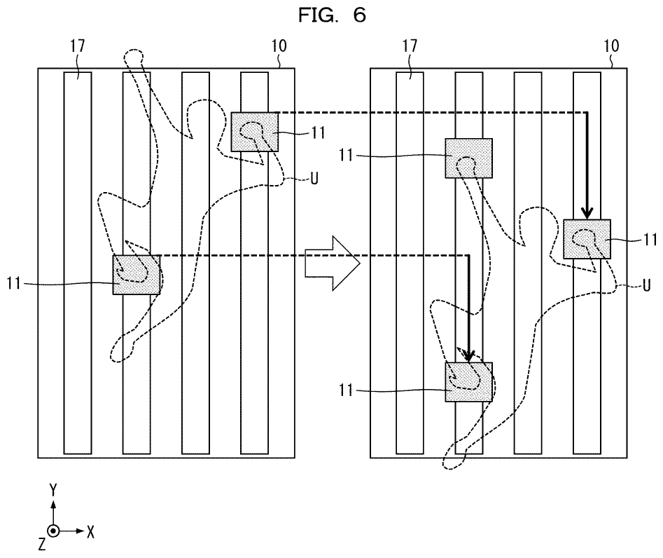

Next, the following adds explanation of the operation of the movement mechanism 17 in the step C4 of FIG. 5. FIG. 6 is a view for explaining an operation example of the movement mechanism 17. In an example of FIG. 6, a direction in which the user U progresses in a climbing experience in a virtual space is an upward direction, that is, a positive Y-axis direction.

As described above, a position of at least part of each of the holds 11 is switchable, in the Z-axis direction which is perpendicular to the surface of the board 10, between a first position in which the user U can put a hand or foot of the user U at the at least part and a second position which is closer to the surface of the board 10 than the first position is.

In a case where the holds 11 do not move, the limited size of the board 10 precludes the user U engaging in climbing from further climbing when the user U arrives at the top part of the board 10, as illustrated in the left drawing of FIG. 6. In order to address this problem, when at least part of each of the holds 11 is in a first position and the user U puts the hand or foot of the user U at the at least part, the hold 11 slowly moves in a direction opposite to the progress direction of the user U, that is, in a negative Y-axis direction, as illustrated in the left and right drawings of FIG. 6. It is desirable that the movement speed of the hold 11 is a speed at which the user U does not sense the acceleration.

Further, when the at least part of each of the holds 11 is recessed to be in the second position and the user U does not put the hand or foot of the user U at the at least part, the hold 11 moves in the progress direction of the user U. The at least part of the hold 11 that has moved then moves to the first position to be lifted up so as to allow the user U to subsequently put the hand or foot of the user U at the hold 11.

For example, in a case where the movement mechanism 17 is achieved with use of a belt, the process of causing the holds 11 to move in the progress direction of the user U includes movement of the holds 11 in the progress direction of the user U via the back surface or inside of the board 10. Further, in a case where each of the holds 11 is configured not to move to the back surface or inside of the board 10, the hold 11 is recessed to be in the second position immediately after the user U releases the hand or foot of the user U from the hold 11. The hold 11 then moves in the progress direction of the user U and is lifted up to be in the first position.

The processes described above enable the user U to feel as if the user U climbed in a certain direction within the front surface of the board 10 without interruption. Further, these descriptions apply, with the top and the bottom reversed, to a case where the user U descends the wall surface in the climbing experience.

The configuration described above enables a relatively small-scale configuration to provide the user U with a climbing experience with a distance beyond a certain point. In addition, use of the HMD 3 makes it possible to achieve a more realistic climbing experience.

### <Variation>

For example, the system S may include a cushioning material enclosing the interface apparatus 1. Even in a case where the user U falls from the board 10, this configuration makes it possible to prevent the user U from being injured due to collision with the floor surface.

Further, as described above, the HMD 3 may include, instead of the function of emitting light, a sensor (for example, a gyrosensor) for detecting a movement of the head of the user U. In this case, the interface apparatus 1 may not include the photodetectors 13.

Furthermore, the system S may include an air blower which is not illustrated. This air blower is provided so as to blow wind toward the user U and operates on the basis of the control signal which has been inputted from the simulation apparatus 2. This makes it possible to further increase reality and a challenge level of a climbing experience in a virtual space.

The holds 11 may be each configured to be movable also in the X-axis direction with use of the movement mechanism 17, or the system S may provide a climbing experience in which the user U moves in a lateral direction of the board 10, that is, in the X-axis direction.

Further, the simulation apparatus 2 may be configured to, in a case where the simulation apparatus 2 determines that a predetermined fall condition is satisfied with reference to information provided from the interface apparatus 1, generate an image in which the user U has fallen from the wall surface for the climbing experience in the virtual space and provide the image to the HMD 3. Examples of cases that satisfy the fall condition include the followings: any of the force sensors 12 no longer detect a force and a moment; the both force sensors 12 corresponding to the positions of the both hands of the user U no longer detect a force and a moment; and the sling belt mechanism 19 detects a weight of not less than a predetermined value.

A configuration is possible, for example, in which a challenge level of the climbing experience is set as appropriate through input by the user U to the simulation apparatus 2 or alternatively in which in an isolated climbing experience, the challenge level is automatically changed in accordance with a skill level of the user U determined on the basis of, for example, the movement speed of the user U. The challenge level of the climbing experience is raised by, for example, the following operations: the simulation apparatus 2 performs control to reduce an amount by which the part of the hold 11 in the first position is lifted up in the positive Z-axis direction; the simulation apparatus 2 controls the tilt mechanism 18 so as to increase the angle θ between the board 10 and the floor surface; and the simulation apparatus 2 increases the speed of the wind blown by the air blower described above.

### [Software Implementation Example]

Functions of the simulation apparatus 2 (hereinafter referred to as a “device”) can be realized by a program for causing a computer to function as the device, the program causing the computer to function as control blocks (in particular, the processor 21) of the device.

In this case, the device includes, as hardware for executing the program, a computer including at least one control device (e.g., a processor) and at least one storage device (e.g., a memory). The functions described in the above embodiments are realized by the program being executed by the at least one control device and the at least one storage device.

The program may be recorded in one or more non-transitory computer-readable recording media. The recording media may be included in the device or need not be included in the device. In the latter case, the program may be supplied to the device via any wired or wireless transmission medium.

Furthermore, some or all of functions of the control blocks can also be realized by a logic circuit. For example, the present invention encompasses, in its scope, an integrated circuit in which a logic circuit that functions as each of the above-described control blocks is formed. In addition, the function of each of the control blocks can be realized by, for example, a quantum computer.

The processes described in the above embodiments may be carried out by artificial intelligence (AI). In this case, AI may be operated in the control device, or may be operated in another device (e.g., an edge computer or a cloud server).

Aspects of the present invention can also be expressed as follows:

An interface apparatus in accordance with Aspect 1 of the present invention is an interface apparatus configured to provide a user with a climbing experience in a virtual space, the interface apparatus including: a board to which holds are attached, the user being to put a hand or a foot of the user at each of the holds; a movement mechanism configured to move positions of the holds on the board; force sensors which are provided to at least one selected from the group consisting of (i) the holds and (ii) gloves and shoes worn by the user and which each detect a force and a moment that are applied from the user to a corresponding one of the holds or that are applied from each of the holds to the user; and an input and output section that provides a signal indicative of the force and the moment to a simulation apparatus configured to generate the virtual space and that acquires, from the simulation apparatus, a control signal for controlling the movement mechanism so as to move the holds.

An interface apparatus board in accordance with Aspect 2 of the present invention may be configured, in Aspect 1, to further include a tilt mechanism which supports the board such that the board is tiltable, wherein the input and output section may acquire, from the simulation apparatus, control signal a for controlling the tilt mechanism so as to tilt the board.

An interface apparatus board in accordance with Aspect 3 of the present invention may be configured, in Aspect 1 or 2, such that a position of at least part of each of the holds is switchable, in a direction perpendicular to a surface of the board, between a first position in which the user is able to put the hand or the foot of the user at the at least part and a second position which is closer to the surface of the board than the first position is; and each of the holds is configured to: when at least part thereof is in the first position and the hand or the foot of the user is put at the at least part, move in a direction opposite to a direction in which the user progresses in the climbing experience in the virtual space; and when the at least part is in the second position and the hand or the foot of the user is not put at the at least part, move in the direction in which the user progresses.

A climbing experience system in accordance with Aspect 4 of the present invention may be configured to include: the interface apparatus in accordance with any one of Aspects 1 to 3; and the simulation apparatus, wherein the simulation apparatus may determine the positions of the holds on the board in view of a position of the user in the virtual space and a posture of the user which posture has been specified by the force and the moment.

The climbing experience system in accordance with Aspect 5 of the present invention may be configured, in Aspect 4, to further include a head mounted display which displays an image that represents the virtual space and that has been acquired from the simulation apparatus.

A climbing experience system in accordance with Aspect 6 of the present invention may be configured, in Aspect 5, such that the simulation apparatus generates an image representing the virtual space that includes part or whole of a body of the user in the posture specified and provides the image to the head mounted display.

The climbing experience system in accordance with Aspect 7 of the present invention may be configured, in Aspect 5 or 6, such that the head mounted display emits light in a predetermined direction; and the interface apparatus includes a plurality of photodetectors each configured to detect light which has been emitted from the head mounted display and provides, via the input and output section, the simulation apparatus with information indicative of a photodetector that has detected the light, as information for specifying an orientation of the head mounted display.

A climbing experience system in accordance with Aspect 8 of the present invention may be configured such that, in any one of Aspects 5 to 7, such that in a case where the simulation apparatus, with reference to information which has been provided by the interface apparatus, determines that a predetermined condition has been satisfied, the simulation apparatus generates an image in which the user has fallen from a wall surface for the climbing experience in the virtual space and provides the image to the head mounted display.

1. An interface apparatus configured to provide a user with a climbing experience in a virtual space, the interface apparatus comprising:
a board to which holds are attached, the user being to put a hand or a foot of the user at each of the holds;
a movement mechanism configured to move positions of the holds on the board;
force sensors which are provided to at least one selected from the group consisting of (i) the holds and (ii) gloves and shoes worn by the user and which each detect a force and a moment that are applied from the user to a corresponding one of the holds or that are applied from each of the holds to the user; and
an input and output section that provides a signal indicative of the force and the moment to a simulation apparatus configured to generate the virtual space and that acquires, from the simulation apparatus, a control signal for controlling the movement mechanism so as to move the holds.

2. The interface apparatus according to claim 1, further comprising a tilt mechanism which supports the board such that the board is tiltable,
the input and output section acquiring, from the simulation apparatus, a control signal for controlling the tilt mechanism so as to tilt the board.

3. The interface apparatus according to claim 1, wherein:
a position of at least part of each of the holds is switchable, in a direction perpendicular to a surface of the board, between a first position in which the user is able to put the hand or the foot of the user at the at least part and a second position which is closer to the surface of the board than the first position is; and
each of the holds is configured to:
when at least part thereof is in the first position and the hand or the foot of the user is put at the at least part, move in a direction opposite to a direction in which the user progresses in the climbing experience in the virtual space; and
when the at least part is in the second position and the hand or the foot of the user is not put at the at least part, move in the direction in which the user progresses.

4. A climbing experience system comprising:
the interface apparatus according to claim 1; and
the simulation apparatus,
the simulation apparatus determining the positions of the holds on the board in view of a position of the user in the virtual space and a posture of the user which posture has been specified by the force and the moment.

5. The climbing experience system according to claim 4, further comprising a head mounted display which displays an image that represents the virtual space and that has been acquired from the simulation apparatus.

6. The climbing experience system according to claim 5, wherein the simulation apparatus generates an image representing the virtual space that includes part or whole of a body of the user in the posture specified and provides the image to the head mounted display.

7. The climbing experience system according to claim 5, wherein
the head mounted display emits light in a predetermined direction; and
the interface apparatus includes a plurality of photodetectors each configured to detect light which has been emitted from the head mounted display and provides, via the input and output section, the simulation apparatus with information indicative of a photodetector that has detected the light, as information for specifying an orientation of the head mounted display.

8. The climbing experience system according to claim 5,
wherein in a case where the simulation apparatus, with reference to information which has been provided by the interface apparatus, determines that a predetermined condition has been satisfied, the simulation apparatus generates an image in which the user has fallen from a wall surface for the climbing experience in the virtual space and provides the image to the head mounted display.
